(19) United States
(12) Patent Application Publication
(10) Pub. No.: US 2018/0183017 A1
(43) Pub. Date: Jun. 28, 2018

(54) PACKAGING MATERIAL FOR POWER STORAGE DEVICES, PACKAGING CASE FOR POWER STORAGE DEVICES, AND POWER STORAGE DEVICE

(71) Applicant: SHOWA DENKO PACKAGING CO., LTD., Isehara-shi (JP)

(72) Inventor: Yuji MINAMIBORI, Isehara-shi (JP)

(73) Assignee: SHOWA DENKO PACKAGING CO., LTD., Isehara-shi (JP)

(21) Appl. No.: 15/845,136

(22) Filed: Dec. 18, 2017

(30) Foreign Application Priority Data
Dec. 28, 2016 (JP) 2016-254888

(51) Int. Cl. H01M 2/02; B32B 15/08; H01M 2/08

(52) U.S. Cl. CPC H01M 2/0292; B32B 15/08; H01M 2/08; B32B 2250/05; H01M 2220/30; B32B 2363/00; B32B 2367/00; B32B 2375/00; B32B 2457/10; B32B 2307/7242

(57) ABSTRACT

A packaging material 1 for power storage devices includes a base material layer 2 made of a heat resistant resin, a sealant layer 3 as an inner layer, and a metal foil layer 4 arranged between the base material layer and the sealant layer. A protective layer 7 is laminated on a surface of the base material layer 2 opposite to a metal foil layer side. The protective layer 7 contains 40 mass % or more of a polyester resin formed by polyester polyol having a number average molecular weight of 5,000 to 50,000 and having a hydroxyl group or a carboxyl group independently at least at respective both ends thereof and a multifunctional isocyanate curing agent containing at least an aliphatic polyfunctional isocyanate compound.

### TECHNICAL FIELD

The present invention relates to a packaging material for power storage devices, such as, e.g., batteries or capacitors used for mobile devices such as smartphones and tablets, and batteries or capacitors used to store electricity for hybrid vehicles, electric vehicles, wind power generation systems, solar power generation systems, and nighttime electricity storages. It also relates to a power storage device packaged with the packaging material.

Note that in claims and specification of the present application, the term “polyester polyol” is used to include the meaning of:

1) polyester having a hydroxyl group at respective both ends of a main chain in a longitudinal direction thereof;

2) polyester having a carboxyl group at respective both ends of the main chain in a longitudinal direction thereof; and

3) polyester having a hydroxyl group at one end of a main chain in a longitudinal direction thereof and a carboxyl group at the other end thereof.

### BACKGROUND ART

In recent years, with the slimming down and weight reduction of mobile electric devices such as smart phones and tablet terminals, as a packaging material of power storage devices such as lithium-ion secondary batteries, lithium polymer secondary batteries, lithium-ion capacitors, electric double layer capacitors, etc., in place of a conventional metal can, a laminate composed of a heat resistant resin layer (base material layer)/adhesive layer/metal foil layer/adhesive layer/thermoplastic resin layer (inner sealant layer) is used (see Patent Document 1). Furthermore, a power source for electric vehicles, etc., a large-sized power source for storage applications, capacitors and the like are increasingly packaged with the laminate (packaging material) having the aforementioned structure. Stretch forming or deep drawing is performed on the laminate, so that the laminate is formed into a three-dimensional shape, such as, e.g., a substantially rectangular parallelepiped shape. By forming such a three-dimensional shape, an accommodation space for accommodating a power storage device main body can be secured.

In addition, in order to improve the protection and the formability (slipperiness) of a packaging material, a configuration in which a matte varnish layer (protective layer) is provided outside a base material layer has also been proposed. As the matte varnish layer, for example, it is described to use a matte varnish in which an appropriate amount of a silica based or kaolin based inorganic material based matting agent is added to an olefin based or alkyd based synthetic resin, such as, e.g., a cellulose based, a polyamide based, a vinyl chloride based, a modified polyolefin based, a rubber based, an acrylic based, an urethane based synthetic resin (see Patent Document 2).

Patent Document 1: Japanese Unexamined Patent Application Publication No. 2003-288865

Patent Document 2: Japanese Unexamined Patent Application Publication No. 2011-54563

### Problems to be Solved by the Invention

By the way, in a packaging material for batteries, an electrolyte (containing a solvent) sometimes adheres to a surface (outer surface) of a packaging material when injecting an electrolyte into a main body during a battery manufacturing process. If solvent resistance on the outer surface of the packaging material is poor, the packaging material becomes poor in appearance. For example, when a protective layer is formed with a urethane based resin, the formability of the packaging material is good, but the solvent resistance of the outer surface of the packaging material is poor (sufficient solvent resistance cannot be obtained).

In addition, when a protective layer is formed with a fluorine based resin, although the solvent resistance of the packaging material is good, the adhesiveness of characters, barcodes, etc., to be printed on the surface (outer surface) of the packaging material is insufficient, and bleeding is likely to occur in print, etc. Thus, there was a problem that the printability was poor.

The present invention was made in view of such technical background, and aims to provide a packaging material for power storage devices, a packaging case for power storage devices, and a power storage device which are excellent in formability, excellent in printability on a surface, and excellent in solvent resistance.

### SUMMARY OF THE INVENTION

### Means for Solving the Problems

In order to attain the aforementioned object, the present invention provides the following means.

[1] A packaging material for power storage devices, comprising:

a base material layer made of a heat resistant resin;

a sealant layer as an inner layer; and

a metal foil layer arranged between the base material layer and the sealant layer,

wherein a protective layer is laminated on a surface of the base material layer opposite to a metal foil layer side, and

wherein the protective layer contains 40 mass % or more of a polyester resin formed by polyester polyol having a number average molecular weight of 5,000 to 50,000 and having a hydroxyl group or a carboxyl group independently at least at respective both ends thereof and a multifunctional isocyanate curing agent containing at least an aliphatic polyfunctional isocyanate compound.

[2] The packaging material for power storage devices as recited in the aforementioned Item [1], wherein an equivalent ratio [NCO]/[OH+COOH] is 0.5 to 5, the equivalent ratio being a ratio of the number of moles of an isocyanate group of the multifunctional isocyanate curing agent to a sum of the number of moles of the hydroxyl group and the number of moles of the carboxyl group.

[3] The packaging material for power storage devices as recited in the aforementioned Items [1] or [2], wherein the aliphatic polyfunctional isocyanate compound is at least one aliphatic polyfunctional isocyanate compound selected from the group consisting of an adduct of trimethylolpropane and an aliphatic diisocyanate compound and an adduct of pentaerythritol and an aliphatic diisocyanate compound.

[4] The packaging material for power storage devices as recited in any one of the aforementioned Items [1] to [3], wherein the polyester resin composing the protective layer is a polyester resin formed by the polyester polyol, the multifunctional isocyanate curing agent, and a trihydric or higher polyhydric alcohol.

[5] The packaging material for power storage devices as recited in any one of the aforementioned Items [1] to [4], wherein the protective layer contains solid fine particles having an average particle diameter of 1 μm to 10 μm.

[6] The packaging material for power storage devices as recited in any one of the aforementioned Items [1] to [5], wherein the protective layer contains a lubricant.

[7] The packaging material for power storage devices as recited in any one of the aforementioned Items [1] to [6], wherein a colored layer is arranged between the base material layer and the metal foil layer.

[8] The packaging material for power storage devices as recited in the aforementioned Item [7], wherein the base material layer and the colored layer are integrally laminated via an easily adhesive layer.

[9] A packaging case for power storage devices, the packaging case being composed of a shaped body of the packaging material for power storage devices as recited in any one of the aforementioned Items [1] to [8].

[10] A power storage device, comprising:

a power storage device main body; and

a packaging material composed of the packaging material for power storage devices as recited in any one of the aforementioned Items [1] to [8] and/or the packaging case for power storage device as recited in the aforementioned Item [9],

wherein the power storage device main body is packaged with the packaging material.

### Effects of the Invention

In the invention recited in the aforementioned Item [1], it is configured such that the protective layer contains 40 mass % or more of a polyester resin formed by polyester polyol having a number average molecular weight of 5,000 to 50,000 and having a hydroxyl group or a carboxyl group independently at least at respective both ends thereof and a multifunctional isocyanate curing agent including at least an aliphatic polyfunctional isocyanate compound. Therefore, the packaging material is excellent in formability, and enables printing on the surface (the surface of the protective layer) in good condition. Furthermore, the surface of the protective layer is excellent in solvent resistance.

In the invention recited in the aforementioned Item [2], the equivalent ratio [NCO]/[OH+COOH] is within the range of 0.5 to 5. Therefore, printing can be performed on the surface of the packaging material (the surface of the protective layer) in a better condition, and the solvent resistance of the surface of the protective layer can be further improved.

In the invention recited in the aforementioned Item [3], the aliphatic polyfunctional isocyanate compound is the aforementioned specific aliphatic polyfunctional isocyanate compound. Therefore, printing can be performed on the surface of the packaging material (the surface of the protective layer) in a better condition, and the solvent resistance of the surface of the protective layer can be further improved.

In the invention recited in the aforementioned Item [4], the polyester resin composing the protective layer is a resin formed by polyester polyol, a multifunctional isocyanate curing agent, and trihydric or higher polyhydric alcohol. Therefore, the crosslink density of the resin becomes high, which further improves the solvent resistance of the surface of the packaging material (the surface of the protective layer).

In the invention recited in the aforementioned Item [5], the protective layer contains solid fine particles having an average particle diameter of 1 μm to 10 μm. Therefore, the formability of the packaging material can be further improved.

In the invention recited in the aforementioned Item [6], the protective layer contains a lubricant. Therefore, the slipperiness of the surface of the packaging material (the surface of the protective layer) can be improved, which in turn can improve the formability.

In the invention recited in the aforementioned Item [7], a colored layer is arranged between the base material layer (heat resistant resin layer) and the metal foil layer. Therefore, the color of the colored layer can be seen through the base material layer (heat resistant resin layer), which can improve the design of the packaging material. In addition, since the colored layer is arranged on the inner side with respect to the base material layer, scratching and color separation are less likely to occur, and therefore durability can be secured.

In the invention recited in the aforementioned Item [8], since the base material layer and the colored layer are integrally laminated via an easily adhesive layer, it is possible to sufficiently prevent the colored layer from peeling from the base material layer at the time of shaping the packaging material.

According to the invention as recited in the aforementioned item [9], it is possible to provide a packaging case for power storage devices which is capable of securing excellent printability on the surface, excellent in solvent resistance and shaped in good condition.

In the invention recited in the aforementioned Item [10], it is possible to provide a power storage device packaged by the packaging material for power storage devices or the packaging case which is capable of securing excellent printability on the surface, excellent in solvent resistance and shaped in good condition.

### BRIEF DESCRIPTION OF THE DRAWINGS

Embodiments of the present invention are shown by way of example, and not limitation, in the accompanying figures.

FIG. 1 is a cross-sectional view showing one embodiment of a packaging material for power storage devices according to the present invention.

FIG. 2 is a cross-sectional view showing one embodiment of a power storage device according to the present invention.

FIG. 3 is a perspective view showing a packaging material (planar shape), a power storage device main body, and a packaging case (three-dimensionally shaped body) composing the power storage device of FIG. 2 in a state before heat-sealing them.

### EMBODIMENT FOR CARRYING OUT THE INVENTION

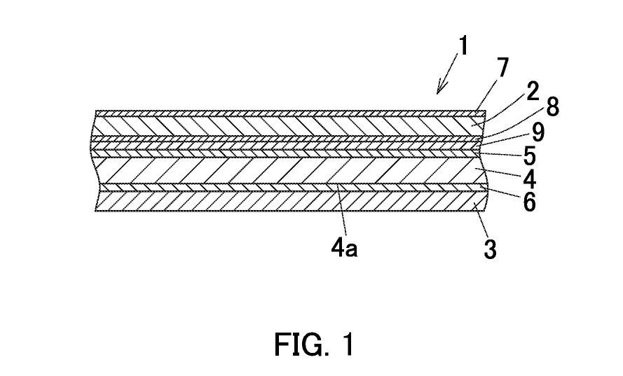

An embodiment of a packaging material 1 for power storage devices according to the present invention is shown in FIG. 1. The packaging material 1 for power storage devices of this embodiment is suitably used as a packaging material for lithium ion secondary battery cases, but is not particularly limited to such use.

The packaging material 1 for power storage devices is configured such that a base material layer (heat resistant resin layer) 2 is integrally laminated on one surface (upper surface) of the metal foil layer 4 via a first adhesive layer (outer adhesive layer) 5, a sealant layer (inner layer) 3 is integrally laminated on the other surface (lower surface) of the metal foil layer 4 via a second adhesive layer (inner adhesive layer) 6, and a protective layer 7 is integrally laminated on the surface of the base material layer 2 opposite to the metal foil layer 4 side (See FIG. 1).

In this embodiment, an easily adhesive layer 8 is laminated on the lower surface of the base material layer (heat resistant resin layer) 2, a colored layer 9 is laminated on the lower surface of the easily adhesive layer 8, and the colored layer 9 and the metal foil layer 4 are integrally adhered via a first adhesive layer 5 (see FIG. 1). That is, the colored layer 9 is arranged between the metal foil layer 4 and the base material layer (heat resistant resin layer) 2. In this embodiment, the easily adhesive layer 8 is laminated on the lower surface of the base material layer (heat resistant resin layer) 2 by a gravure coating method, and the colored layer 9 is laminated by printing on the lower surface of the easily adhesive layer 8.

### [Protective Layer]

In the present invention, it is configured such that the protective layer 7 contains 40 mass % or more of a polyester resin formed by polyester polyol having a number average molecular weight of 5,000 to 50,000 and having a hydroxyl group or carboxyl group independently at least at respective both ends of a main chain and a multifunctional isocyanate curing agent including at least an aliphatic polyfunctional isocyanate compound. Since such a structure is adopted, the packaging material 1 of the present invention is excellent in formability, printing can be performed in good condition on the surface of the packaging material (the surface of the protective layer 7), and the surface of the protective layer 7 is also excellent in solvent resistance.

As the polyester polyol, for example, it is preferable to use polyester polyol having a hydroxyl group or a carboxyl group independently at least at respective both ends, obtained by mixing polyhydric alcohol and polybasic carboxylic acid to perform a condensation polymerization reaction in view of further improving the solvent resistance. That is, it is preferable that the polyester polyol be a condensation polymer of polyhydric alcohol and polybasic carboxylic acid. For example, the “polyester polyol having a hydroxyl group or a carboxyl group independently at least at respective both ends” can be produced by blending polyhydric alcohol and dicarboxylic acid to cause a condensation polymerization reaction at 210° C. for 20 hours. The polyhydric alcohol is not particularly limited, but examples thereof include ethylene glycol, diethylene glycol, propylene glycol, dipropylene glycol, 1,6-hexanediol, neopentyl glycol, 1,4-butylene glycol, trimethylolpropane, glycerin, 1,9-nanoediol, 3-methyl-1,5-pentanediol, and the like. The polybasic carboxylic acid is not particularly limited, but examples thereof include dicarboxylic acids such as aliphatic dicarboxylic acid and aromatic dicarboxylic acid. The aliphatic dicarboxylic acid is not particularly limited, but examples thereof include adipic acid, succinic acid, azelaic acid, suberic acid, sebacic acid, glutaric acid, maleic anhydride, itaconic anhydride and the like. The aromatic dicarboxylic acid is not particularly limited, but examples thereof include isophthalic acid, terephthalic acid, naphthalene dicarboxylic acid, tetrahydrophthalic anhydride, hexahydrophthalic anhydride, phthalic anhydride, trimellitic acid, pyromellitic acid and the like.

As the polyester polyol, polyester polyol having a number average molecular weight (Mn) of 5,000 to 50,000 is used. If the number average molecular weight is less than 5,000, the solvent resistance is poor, and when a solvent adheres to the outer surface of the packaging material, the surface of the protective layer becomes white and cloudy. On the other hand, if the number average molecular weight exceeds 50,000, the viscosity increases and the viscosity of the coating liquid increases, causing problems such as difficulty in coating or deterioration in coatability. In particular, the number average molecular weight of the polyester polyol is preferably 8,000 to 40,000, particularly preferably 10,000 to 30,000. The coating property (application property) can be sufficiently improved when the number average molecular weight of polyester polyol is within the range of 5,000 to 45,000.

The number average molecular weight of the polyester polyol is a value of a polystyrene equivalent value by gel permeation chromatography (GPC). Specifically, for example, it is a number average molecular weight measured by using polystyrene whose molecular weight is known as a standard sample at a column temperature of 40° C. using KF805L, KF803L, and KF802 (manufactured by Showa Denko K.K.) as columns, using tetrahydrofuran (THF) as an eluent, at a flow rate of 0.2 mL/min, a detector: a differential refractive index (RI) meter, and a sample concentration of 0.02 mass %.

The aliphatic polyfunctional isocyanate compound (curing agent) is not particularly limited, but examples thereof include hexamethylene diisocyanate (HMDI), tetramethylene diisocyanate, 1,2-propylene diisocyanate, isophorone diisocyanate (IPDI), and the like. As described above, the aliphatic polyfunctional isocyanate compound includes both acyclic and cyclic (alicyclic) compounds. Modified products of aliphatic polyfunctional isocyanate compounds may also be used. As a modified product of the aliphatic polyfunctional isocyanate compound, although not particularly limited, examples thereof include aliphatic polyfunctional isocyanate compound modified products obtained by a multimerization reaction of isocyanurate formation, polymerization, carbodiimide formation and the like. Specific examples thereof include dimers, trimers, biurets, and allophanates of aliphatic polyfunctional isocyanate compounds, a polyisocyanate having a 2,4,6-oxadiazinetrione ring obtained from carbonic acid gas and an aliphatic polyfunctional isocyanate compound monomer, and the like.

Among them, as the aliphatic polyfunctional isocyanate compound, it is preferable to use at least one aliphatic polyfunctional isocyanate compound selected from the group consisting of an adduct of trimethylolpropane and aliphatic polyfunctional isocyanate compound and an adduct of pentaerythritol and aliphatic polyfunctional isocyanate compound. It is particularly preferable to use at least one aliphatic polyfunctional isocyanate compound selected from the group consisting of an adduct of trimethylolpropane and aliphatic diisocyanate compound and an adduct of pentaerythritol and aliphatic diisocyanate compound.

As the curing agent, an aromatic polyfunctional isocyanate compound may be used together with the aliphatic polyfunctional isocyanate compound within a range in which the effect of the present invention is not impaired. Examples of the aromatic polyfunctional isocyanate compound include, but are not limited to, tolylene diisocyanate (TDI), diphenylmethane diisocyanate (MDI), methylenediphenyl diisocyanate, and the like.

The content rate of the aliphatic polyfunctional isocyanate compound in the multifunctional isocyanate curing agent is preferably set to 30 mass % to 100 mass %, more preferably 50 mass % to 100 mass %, particularly preferably 70 mass % to 100 mass %.

The polyester resin composing the protective layer 7 may be a polyester resin formed by “polyester polyol”, “the multifunctional isocyanate curing agent including the aliphatic polyfunctional isocyanate compound”, and “aliphatic compound having a plurality of functional groups capable of reacting with isocyanate group in one molecule”. The aliphatic compound also includes compounds in which atoms of, e.g., oxygen, nitrogen, sulfur, and chlorine are bonded. The aliphatic compound does not include the polyester polyol and the polyfunctional isocyanate compound. As the aliphatic compound, it is preferable to use one having a molecular weight smaller than the number average molecular weight of the polyester polyol. In this case, the curing reaction progresses quickly, and therefore there is an advantage that the productivity can be improved. Further, even if a manufacturing process is adopted in which a metal foil and a sealant film (sealant layer) are laminated after forming the protective layer when manufacturing the packaging material, it is possible to sufficiently prevent the protective layer from adhering to the roll of the processing machine and peeling off (contaminating the surface of the roll). In particular, the molecular weight of the “aliphatic compound having a plurality of functional groups capable of reacting with an isocyanate group in one molecule” is more preferably 60 to 9,500, particularly preferably within a range of 100 to 1,000.

With respect to the aliphatic compound, the functional group capable of reacting with an isocyanate group is not particularly limited, but examples thereof include a hydroxyl group, an amino group, and a carboxyl group. The “aliphatic compound having a plurality of functional groups capable of reacting with an isocyanate group in one molecule” is not specifically limited, but examples thereof include polyhydric alcohol, aliphatic diamine, dicarboxylic acid and the like. The polyhydric alcohol is alcohol having two or more alcoholic hydroxyl groups in one molecule. The polyhydric alcohol is not particularly limited, but examples thereof include trimethylolethane, trimethylolpropane (TMP), trimethylolbutane, pentaerythritol, 1,2,6-hexanetriol, methylpentanediol, dimethylbutanediol, ethylene glycol, glycerin, carbitol, sorbitol and the like. Among them, it is preferable to use trihydric or higher polyhydric alcohol.

The content rate of the aliphatic compound in the polyester resin is preferably 1 mass % to 30 mass %. Among them, the content rate is more preferably 1 mass % to 15 mass %, particularly preferably 3 mass % to 10 mass %.

The content rate of the polyester resin in the protective layer 7 is preferably set to 40 mass % to 99.9 mass %. Among them, the content rate of the polyester resin in the protective layer 7 is more preferably set to 50 mass % to 95 mass %, particularly preferably set to 60 mass % to 90 mass %.

It is preferably configured such that the protective layer 7 further includes solid fine particles. By including solid fine particles, good slipperiness is given to the surface (the outer surface of the protective layer 7) of the packaging material 1 for power storage devices, and formability of the packaging material 1 for power storage devices can be further improved. From the viewpoint of improving slipperiness, the gloss value of the surface (outer surface) of the protective layer 7 is preferably set to 30% or less, more preferably 1% to 15%. The gloss value is a value obtained by measuring at a reflection angle of 60° by a gross measuring instrument “micro-TRI-gloss-s” manufactured by a BYK corporation. As the solid fine particles, although not particularly limited, examples thereof include silica fine particles, alumina fine particles, kaolin fine particles, calcium oxide fine particles, calcium carbonate fine particles, calcium sulfate fine particles, barium sulfate fine particles, calcium silicate fine particles, silicone resin beads, acrylic resin beads, fluororesin beads and the like. Among them, silica fine particles, barium sulfate fine particles, and acrylic resin beads are preferably used. As the solid fine particles, solid fine particles having an average particle diameter of 1 μm to 10 μm is preferably used.

The content rate of the solid fine particles in the protective layer 7 is preferably set to 0.1 mass % to 60 mass %. When the content is 0.1 mass % or more, the slipperiness at the time of shaping can be improved. At the same time, when it is 60 mass % or less, the coating process suitability at the time of forming the protective layer can be improved and the shape retention of the protective layer can be sufficiently secured. In particular, the content rate of the solid fine particles in the protective layer 7 is more preferably set to 5 mass % to 45 mass %, particularly preferably set to 10 mass % to 30 mass %.

The protective layer 7 preferably has a configuration containing a lubricant. By including a lubricant, good slipperiness can be given and formability of the packaging material 1 for power storage devices can be further improved. The lubricant is not particularly limited, but examples thereof include fatty acid amide, silicone, wax (polyethylene wax, fluorine-containing polyethylene wax, etc.), and the like.

The protective layer 7 may contain additives. The additive is not particularly limited, but examples thereof include a reaction accelerator and the like. This reaction promoter is for efficiently progressing the reaction between the polyester polyol and the polyfunctional isocyanate compound. The reaction accelerator is not particularly limited, but examples thereof include dibutyltin diacetate, dibutyltin dilaurate, dibutyltin dimaleate, tertiary amines (tributylamine, triethanolamine, etc.), and the like.

The thickness (thickness after drying) of the protective layer 7 is preferably set to 1 μm to 10 μm. In order to set the thickness of the protective layer 7 in such a thin range, it is preferable that the protective layer 7 be formed with a coating film (a coating film formed by coating).

### [Base Material Layer (Heat Resistant Resin Layer)]

The base material layer (heat resistant resin layer) 2 is a member mainly playing a role of ensuring good formability as a packaging material, that is, it plays a role of preventing breakage due to necking of the metal foil at the time of shaping. As the heat resistant resin constituting the base material layer 2, a heat resistant resin which does not melt at the heat sealing temperature when heat sealing the packaging material 1 is used. As the heat resistant resin, it is preferable to use a heat resistant resin having a melting point higher than the melting point of the thermoplastic resin constituting the sealant layer 3 by 10° C. or more, and it is particularly preferable to use a heat resistant resin having a melting point higher than the melting point of the thermoplastic resin by 20° C. or more.

The base material layer (heat resistant resin layer) 2 is preferably composed of a heat resistant resin stretched film having a hot water shrinkage percentage of 2% to 20%. When the hot water shrinkage percentage is 2% or more, peeling of the colored layer 9 from the heat resistant resin layer 2 can be sufficiently prevented at the time of use under a somewhat harsh environment such as high temperature and high humidity. Further, when the hot water shrinkage percentage is 20% or less, it is possible to sufficiently prevent the colored layer 9 of the packaging material 1 from peeling from the heat resistant resin layer 2 when shaping such as deep drawing or stretch forming. In particular, it is preferable to use a heat resistant resin stretched film having a hot water shrinkage percentage of 2.5 to 10% as the heat resistant resin stretched film. In addition, it is more preferable to use a heat resistant resin stretched film having a hot water shrinkage percentage of 3.0% to 6.0%, and particularly preferable to use a eat resistant resin stretched film having a hot water shrinkage percentage of 3.5% to 5.0%.

The “hot water shrinkage percentage” is a dimensional change rate of a test piece (10 cm×10 cm) of a heat resistant resin stretched film 2 in the stretching direction before and after immersion of the test piece in 95° C. hot water for 30 minutes, and can be obtained by the following equation.

Hot water shrinkage percentage (%)={(X−Y)/X}×100

X: Dimension in the stretching direction before the immersion treatment

Y: Dimension in the stretching direction after the immersion treatment

The hot water shrinkage percentage in case of adopting a biaxially stretched film is an average value of the dimensional change rate in the two stretching directions.

The hot water shrinkage percentage of the heat resistant resin stretched polyamide film can be controlled, for example, by adjusting the heat setting temperature during the stretching.

The heat resistant resin stretched film 2 is not particularly limited, but examples thereof include a stretched polyamide film such as a stretched nylon film, a stretched polyester film, and the like. Among them, as the heat resistant resin stretched film 2, it is particularly preferable to use a biaxially stretched polyamide film such as a biaxially stretched nylon film, a biaxially stretched polybutylene terephthalate (PBT) film, a biaxially stretched polyethylene terephthalate (PET) film or a biaxially stretched polyethylene naphthalate (PEN) film. Also, as the heat resistant resin stretched film 2, it is preferable to use a heat resistant resin biaxially stretched film drawn by a simultaneous biaxial stretching method. Further, it is preferable to use a heat resistant resin biaxially stretched film in which a ratio (MD/TD) of the “hot water shrinkage percentage in the M direction” to the “hot water shrinkage percentage in the T direction” is within the range of 0.9 to 1.1. In the case of adopting the configuration in which the ratio (MD/TD) is within the range of 0.9 to 1.1, a packaging material 1 with particularly good formability can be obtained. Note that the “M direction” means a “machine flow direction” and the “T direction” means a “direction orthogonal to the M direction”. The nylon film is not particularly limited, but is exemplified by a 6 nylon film, a 6, 6 nylon film, an MXD nylon film, and the like. The heat resistant resin stretched film layer 2 may be composed of a single layer (single stretched film) or may be composed of multiple layers (e.g., a stretched PET film/an stretched nylon film) composed of, for example, a stretched polyester film/a stretched polyamide film.

Among them, as the heat resistant resin stretched film layer 2, it is preferably to use a biaxially stretched polyamide film having a shrinkage ratio of 2 to 20%, a biaxially stretched polyethylene naphthalate (PEN) film having a shrinkage ratio of 2 to 20% or a biaxially stretched polyethylene terephthalate (PET) film having a shrinkage ratio of 2 to 20%. In this case, the effect of preventing the colored layer 9 from peeling off from the heat resistant resin layer 2 can be further enhanced during, for example, shaping, sealing, or use under a somewhat harsh environment such as high temperature and high humidity, and the like.

The thickness of the base material layer (heat resistant resin layer) 2 is preferably 12 μm to 50 μm. In the case of using a polyester film, it is preferable that the thickness be 12 μm to 50 μm, and in the case of using a nylon film, it is preferable that the thickness be 15 μm to 50 μm. By setting the thickness to a value equal to or larger than the aforementioned preferred lower limit value, it is possible to ensure a sufficient strength as a packaging material. By setting the thickness to a value equal to or smaller than the aforementioned preferred upper limit, it is possible to reduce the stress at the time of shaping such as stretch forming and drawing, thereby improving the formability.

### [Easily Adhesive Layer]

An easily adhesive layer 8 may be laminated on the inner surface (the surface on the metal foil layer 4 side) of the base material layer (heat resistant resin layer) 2. By coating on the surface of the heat resistant resin layer 2 having poor adhesion originally a polar resin or the like excellent in tackiness and adhesiveness to laminate an easily adhesive layer 8, adhesion and adhesiveness to the colored layer 9 can be further improved. It is preferable that the inner surface of the heat resistant resin layer 2 (the surface on which the easily adhesive layer 8 is laminated) be preliminarily subjected to a corona treatment or the like prior to laminating the easily adhesive layer 8 to improve the wettability.

The method for forming the easily adhesive layer 8 is not particularly limited, but, for example, the easily adhesive layer 8 can be formed by applying an aqueous emulsion (aqueous emulsion) of one or two kinds of resins selected from the group consisting of an epoxy resin, a urethane resin, an acrylic acid ester resin, a methacrylic acid ester resin, a polyester resin, and a polyethyleneimine resin on the surface of a base material layer (heat resistant resin layer) 2 and drying the emulsion. The coating method is not particularly limited, but examples thereof include a spray coating method, a gravure roll coating method, a reverse roll coating method, a lip coating method, and the like.

The easily adhesive layer 8 is preferably configured to include one or more resins selected from the group consisting of an epoxy resin, a urethane resin, an acrylic acid ester resin, a methacrylic acid ester resin, a polyester resin, and a polyethyleneimine resin. By adopting such a configuration, it is possible to further improve the adhesive force between the heat resistant resin layer 2 and the colored layer 9. Further, when the packaging material is subjected to shaping such as deep drawing, stretch forming or the like, it is possible to sufficiently prevent the colored layer 9 from peeling from the heat resistant resin layer 2 when sealing the packaging material for sealing. It is also possible to sufficiently prevent the colored layer 9 from peeling from the heat resistant resin layer 2 even when the packaging material 1 is used under a somewhat harsh environment such as high temperature and high humidity.

Among them, the easily adhesive layer 8 is particularly preferably configured to contain a urethane resin and an epoxy resin, or to contain a (meth)acrylate resin and an epoxy resin. In this case, the adhesive strength between the heat resistant resin layer 2 and the colored layer 9 can be further improved.

In the case of adopting the former configuration, the mass ratio of urethane resin/epoxy resin contained in easily adhesive layer 8 is preferably in the range of 98/2 to 40/60, in which case the adhesion between the heat resistant resin layer 2 and the colored layer 9 can be further improved. When the content ratio of the urethane resin is larger than the content mass ratio of the urethane resin/epoxy resin (98/2), the degree of crosslinking will become insufficient. As a result, it becomes difficult to obtain sufficient solvent resistance and adhesive force, which is not preferable. On the other hand, when the content ratio of the urethane resin is smaller than the content ratio of the urethane resin/epoxy resin (40/60), it takes too much time to complete the crosslinking, which is not preferable. In particular, the content mass ratio of urethane resin/epoxy resin in the easily adhesive layer 8 is more preferably in the range of 90/10 to 50/50.

Further, in the case of adopting the latter configuration, the content mass ratio of the (meth) acrylic acid ester resin/epoxy resin in the easily adhesive layer 8 is preferably in the range of 98/2 to 40/60. In this case, the adhesive strength between the heat resistant resin layer 2 and the colored layer 9 can be further improved. When the content ratio of the (meth) acrylic acid ester resin is larger than the content mass ratio (98/2) of the (meth) acrylic acid ester resin/epoxy resin, the degree of crosslinking becomes insufficient. As a result, the solvent resistance and the adhesive strength become sufficient, which is not preferable. On the other hand, when the content ratio of the (meth) acrylic acid ester resin is smaller than the content mass ratio (40/60) of the (meth) acrylic acid ester resin/epoxy resin, the time to complete the crosslinking is too long, which is not preferable. Among them, the content mass ratio of the (meth) acrylic acid ester resin/epoxy resin in the easily adhesive layer 8 is more preferably in the range of 90/10 to 50/50.

A surfactant, such as, e.g., glycols and ethylene oxide adducts of glycol, may be added to the aqueous resin emulsion (resin-aqueous emulsion) for forming the easily adhesive layer 8. In this case, a sufficient defoaming effect can be obtained in the aqueous resin emulsion, so that the easily adhesive layer 8 having excellent surface smoothness can be formed. It is preferable that 0.01 mass % to 2.0 mass % of the surfactant be contained in the aqueous resin emulsion.

The resin aqueous emulsion (resin-aqueous emulsion) for forming the easily adhesive layer 8 preferably contains inorganic fine particles such as silica and colloidal silica. In this case, an anti-blocking effect can be obtained. The inorganic fine particles are preferably added in the amount of 0.1 parts by mass to 10 parts by mass with respect to 100 parts by mass of the resin content.

The formation amount of the easily adhesive layer 8 (solid content after drying) is preferably in the range of 0.01 g/m² to 0.5 g/m². When it is 0.01 g/m² or more, the heat resistant resin stretched film layer 2 and the colored ink layer 9 can be adhered sufficiently, and when it is 0.5 g/m² or less, cost reduction can be performed, which is economical.

The content rate of the resin in the easily adhesive layer (after drying) 8 is preferably 88 mass % to 99.9 mass %.

### [Colored Layer]

It may be configured such that the colored layer 9 is disposed between the base material layer 2 and the metal foil layer 4. By adopting such a configuration, it is possible to impart color (including achromatic color) and design to the outer surface side of the packaging material 1.

The colored layer 9 is not particularly limited, but examples thereof include a black ink layer, a white ink layer, a gray ink layer, a red ink layer, a blue ink layer, a green ink layer, a yellow ink layer, and the like.

The black ink layer 9 will be described. The black ink layer 9 is usually made of a composition containing carbon black.

In particular, it is preferably configured such that the black ink layer 9 contains carbon black, diamine, polyol, and curing agent, but it is not particularly limited to such a configuration.

In the black ink layer (ink layer after drying) 9, it is preferable that the content rate of the carbon black be 15 mass % to 60 mass % and that the total content rate of the diamine, the polyol, and the curing agent be 40 mass % to 85 mass %. In particular, it is particularly preferable that the content rate of the carbon black be 20 mass % to 50 mass %.

When the content rate of the carbon black is less than 15 mass %, metallic luster feeling due to the metal foil layer 4 remains, so that heavy feeling is impaired and partial color unevenness tends to occur when shaping, which is not preferable. On the other hand, when the content rate of the carbon black exceeds 60 mass %, the black ink layer 9 becomes hard and brittle, so that the adhesion to the metal foil layer 4 is lowered. As a result, at the time of shaping, peeling may occur between the metal foil layer 4 and the black ink layer 9, which is not preferable.

It is preferable that the black ink layer 9 contain 2 parts by mass to 20 parts by mass of the curing agent per 100 parts by mass of the total amount of the carbon black, the diamine, and the polyol. When the curing agent is less than 2 parts by mass, peeling becomes likely to occur between the metal foil layer 4 and the black ink layer 9 during shaping. When the curing agent exceeds 20 parts by mass, blocking occurs when unrolling (rolling out) the packaging material 1 in a rolled state, which becomes likely to cause troubles such as occurrence of transfer and adhesion on the outer surface of the heat resistant resin layer 2 and the sealant layer (thermoplastic resin layer) 3, which is not preferable.

As the carbon black, one having an average particle diameter of 0.2 μm to 5 μm is preferably used.

The diamine is not particularly limited, but examples thereof include ethylenediamine, dimer diamine, 2-hydroxyethylethylenediamine, 2-hydroxyethylpropylenediamine, dicyclohexylmethanediamine, 2-hydroxyethylpropylenediamine and the like. Among them, it is preferable to use one or two or more diamines selected from the group consisting of ethylenediamine, dimer diamine, 2-hydroxyethylethylenediamine, 2-hydroxyethylpropylenediamine, and dicyclohexylmethanediamine as the diamine.

The diamine has a higher reaction rate with a curing agent (isocyanate and the like) than polyol, and realizes curing in a short time. That is, the diamine reacts with the curing agent together with the polyol to promote crosslinking curing of the ink composition.

The polyol is not particularly limited, but it is preferable to use one or two or more polyols selected from the group consisting of polyurethane based polyol, polyester based polyol, and polyether based polyol.

The number average molecular weight of the polyol is preferably in the range of 1,000 to 8,000. When it is 1,000 or more, it is possible to increase the adhesive strength after curing, and when it is 8,000 or less, the reaction rate with the curing agent can be increased.

The curing agent is not particularly limited, but examples thereof include isocyanate compounds and the like. As the isocyanate compound, for example, various isocyanate compounds of aromatic type, aliphatic type, and alicyclic type can be used. Specific examples thereof include tolylene diisocyanate (TDI), diphenylmethane diisocyanate, hexamethylene diisocyanate (HMDI), isophorone diisocyanate, and the like.

The colored ink layer (excluding the black ink layer) 9 will be described. It is preferably configured such that the colored ink layer (excluding the black ink layer) 9 is composed of a cured film of an ink composition including: a two-part curing type polyester urethane resin binder composed of a polyester resin as a main agent; and a polyfunctional isocyanate compound as a curing agent and a color pigment containing an inorganic pigment.

As the color pigment, a configuration including at least an inorganic pigment may be adopted. As the color pigment, in addition to the inorganic pigment, for example, an azo pigment, a phthalocyanine pigment, a condensed polycyclic pigment and the like can be exemplified. In addition, the inorganic pigment is not particularly limited, but examples thereof include carbon black, calcium carbonate, titanium oxide, zinc oxide, iron oxide, aluminum powder, and the like. As the inorganic pigment, one having an average particle diameter of 0.1 μm to 5 μm is preferably used, and one having an average particle diameter of 0.5 μm to 2.5 μm is particularly preferably used. When dispersing the coloring pigment, it is preferable to disperse the color pigment using a pigment dispersing machine. In dispersing the color pigment, a pigment dispersant such as a surfactant can also be used.

It is preferably configured such that 50 mass % or more of the color pigment is composed of the inorganic pigment. In this case, the hiding power for hiding the metal foil layer 4 is more sufficiently obtained, which in turn can form a colored ink layer 9 having a specific color tone capable of sufficiently imparting heavy feeling and luxurious feeling. In particular, it is more preferably configured such that 60 mass % or more of the color pigment is composed of the inorganic pigment.

The thickness (after drying) of the colored layer 9 is preferably 1 μm to 4 μm. When it is 1 μm or more, transparency does not remain in the color tone of the colored layer 9, and the color and gloss of the metal foil layer 4 can be sufficiently concealed. In addition, when it is 4 μm or less, it is possible to sufficiently prevent the colored layer 9 from being partially broken during shaping.

The colored layer 9 is not particularly limited, but can be formed by, for example, printing (applying), for example,

1) an ink composition containing carbon black, diamine, polyol, a curing agent, and an organic solvent, or

2) a colored ink composition containing a two-part curing type polyester urethane resin binder composed of a polyester resin as a main agent and a polyfunctional isocyanate compound as a curing agent, and a color pigment containing an inorganic pigment

on the surface of the easily adhesive layer 8 on the lower surface of the heat resistant resin layer 2 by a gravure printing method or the like.

The organic solvent is not particularly limited, but examples thereof include toluene and the like.

The method of forming the colored layer 9 is not particularly limited, but examples thereof include a gravure printing method, a reverse roll coating method, a lip roll coating method, and the like.

### [Sealant Layer (Inner Layer)]

The sealant layer (inner layer) 3 is formed of a thermoplastic resin layer. The sealant layer (inner layer) 3 plays a role of imparting an excellent chemical resistance against a highly corrosive electrolyte used in lithium ion secondary batteries and the like and also imparting a heat sealing property to the packaging material.

The thermoplastic resin layer 3 is not particularly limited, but is preferably a thermoplastic resin unstretched film layer. The thermoplastic resin unstretched film layer 3 is not particularly limited, but is preferably configured by an unstretched film made of at least one kind of thermoplastic resin selected from the group consisting of polyethylene, polypropylene, an olefin based copolymer, an acid modified product thereof, and an ionomer.

Among them, as the thermoplastic resin layer 3, it is more preferably composed of a three layer structure in which a random copolymer layer containing a copolymerization component other than propylene and propylene as a copolymerization component is laminated on both surfaces of an intermediate layer containing an elastomer-modified olefin-based resin from the viewpoint that insulation can be sufficiently secured during heat sealing.

The elastomer-modified olefin based resin (polypropylene block copolymer) forming the intermediate layer is preferably composed of an elastomer-modified homopolypropylene and/or an elastomer-modified random copolymer. The elastomer-modified random copolymer is an elastomer modified body of a random copolymer containing “propylene” and “other copolymerization component except propylene” as “copolymerization components”. The “other copolymerization component except propylene” is not particularly limited, but examples thereof include olefin components such as ethylene, 1-butene, 1-hexene, 1-pentene, 4-methyl-1-pentene, and butadiene and the like. The elastomer is not particularly limited, but an olefin based thermoplastic elastomer is preferably used. The olefin based thermoplastic elastomer is not particularly limited, but is exemplified by, an EPR (ethylene propylene rubber), a propylene-butene elastomer, a propylene-butene-ethylene elastomer, an EPDM (ethylene-propylene-diene rubber), etc. Among them, an EPR (ethylene propylene rubber) is preferably used. With respect to the elastomer-modified olefin based resin, the mode of the “elastomer modification” may be a modification in which an elastomer is graft polymerized, a modification in which an elastomer is added to an olefin based resin (homopolypropylene and/or the aforementioned random copolymer), or other modified embodiments.

The random copolymer (layer) is a random copolymer containing “propylene” and “other copolymerization component except propylene” as copolymerization components. Regarding the random copolymer, the “other copolymerization components other than propylene” is not particularly limited, but is exemplified by butadiene, etc., in addition to olefin components, such as, e.g., ethylene, 1-butene, 1-hexene, 1-pentene, and 4 methyl-1-pentene.

The thickness of the thermoplastic resin layer 3 is preferably set to 20 μm to 80 μm. By setting the thickness to 20 μm or more, it is possible to sufficiently prevent occurrence of pinholes, and by setting it to 80 μm or less, the amount of resin used can be reduced and cost reduction can be attained. In particular, it is particularly preferable that the thickness of the thermoplastic resin layer 3 be set to 30 μm to 50 μm. The thermoplastic resin layer 3 may be a single layer or multiple layers.

### [Metal Foil Layer]

The metal foil layer 4 plays a role of imparting a gas barrier property that prevents invasion of oxygen and moisture into the packaging material 1. The metal foil layer 4 is not particularly limited, but examples thereof include an aluminum foil, a copper foil, a nickel foil, a stainless steel foil and the like, and an aluminum foil is generally used. As the aluminum foil, A8079H-O and A8021H-O defined in JIS H4160-2006 are preferable. The thickness of the metal foil layer 4 is preferably 20 μm to 100 μm. By setting the thickness to 20 μm or more, it is possible to prevent generation of pinholes at the time of rolling when manufacturing a metal foil, and by setting the thickness to 100 μm or less, it is possible to reduce the stress at the time of stretch forming, drawing, etc., thereby improving the formability.

It is preferable that the metal foil layer 4 be subjected to a chemical conversion treatment at least on the inner surface 4a (the surface on the inner adhesive layer 6 side). By being subjected to such a chemical conversion treatment, corrosion of the surface of the metal foil due to contents (electrolyte of batteries, foods, drugs and medicines, etc.) can be prevented sufficiently. For example, by performing the following treatment, a chemical conversion treatment is subjected to the metal foil. That is, for example, on the surface of metal foil subjected to a degreasing treatment, a chemical conversion treatment is subjected by applying any one of:

1) an aqueous solution composed of a mixture of phosphoric acid, chromic acid, and fluoride of metal salt;

2) an aqueous solution composed of a mixture of phosphoric acid, chromic acid, fluoride metal salt, and fluoride nonmetal salt; and

3) an aqueous solution composed of a mixture of an acrylic resin and/or a phenolic resin, phosphoric acid, chromic acid, and a fluoride metal salt,

and then drying it.

### [Outer Side Adhesive Layer (First Adhesive Layer)]

The outer adhesive layer 5 is not particularly limited, but may be exemplified by, for example, an adhesive layer formed by a two-part curing type adhesive agent. The two-part curing type adhesive agent is not particularly limited, but examples thereof include a two-part curing type urethane based adhesive agent, a two-part curing type polyester urethane based adhesive agent, and the like. The two-part curing type urethane-based adhesive agent is not particularly limited, but examples thereof include a two-part curing type urethane based adhesive agent containing a polyol component and an isocyanate component. This two-part curing type urethane-based adhesive agent is suitably used especially at the time of bonding by a dry lamination method. The polyol component is not particularly limited, but examples thereof include polyester polyol, polyether polyol, and the like. The isocyanate component is not particularly limited, but examples thereof include diisocyanates such as tolylene diisocyanate (TDI), hexamethylene diisocyanate (HMDI), and methylene bis (4, 1-phenylene) diisocyanate (MDI). The thickness of the outer adhesive layer 5 is preferably set to 2 μm to 5 μm, particularly preferably 3 μm to 4 μm. An inorganic or organic anti-blocking agent or an amide based slip agent may be added to the outer adhesive layer 5.

The outer adhesive layer 5 is formed by, for example, applying an adhesive agent such as a two-part curing type adhesive agent, etc., by a gravure coating method, etc., on the “upper surface of the metal foil layer 4” and/or the lower surface of the colored layer 9 laminated via the easily adhesive layer 8 on the lower surface of the heat resistant resin layer 2″. The method of forming the outer adhesive layer 5 is merely an example thereof and is not particularly limited to such a forming method.

### [Inner Side Adhesive Layer (Second Adhesive Layer)]

For the inner adhesive layer 6 which bonds the metal foil layer 4 and the sealant layer 3, in order to prevent degradation over time in lamination strength due to influence of electrolyte, etc., it is preferable to use an adhesive resin having good adhesion for both of the metal foil layer 4 and the sealant layer 3. Although the type of the specific resin is not particularly limited, examples thereof include resins in which dicarboxylic acids such as maleic acid, fumaric acid, itaconic acid, and mesaconic acid, dicarboxylic acid anhydrides such as maleic anhydride, fumaric anhydride, itaconic anhydride, mesaconic anhydride, and the like, a carboxyl group-containing monomer such as acrylic acid, methacrylic acid, crotonic acid, itaconic acid are graft-modified or copolymerized with polypropylene. Among them, it is preferable to use a resin graft-modified with maleic anhydride, acrylic acid or methacrylic acid, particularly maleic anhydride modified polyolefin resin is preferable. The method for producing such a resin is not particularly limited, but examples thereof include a solution method in which polypropylene is dissolved in an organic solvent and reacted with an acid (maleic anhydride or the like) in the presence of a radical generator, and a melting method in which polypropylene is heat-melted and reacted with an acid (such as maleic anhydride) in the presence of a radical generator.

From the viewpoint of increasing the service life of the packaging material by ensuring adequate electrolyte resistance, the inner adhesive layer 6 is particularly preferred to be composed of an adhesive agent composition containing a polyolefin resin having a carboxyl group in its chemical structure and a polyfunctional isocyanate compound. The inner adhesive layer 6 may be obtained by, for example, applying an adhesive liquid containing a polyolefin resin having a carboxyl group, a polyfunctional isocyanate compound, and an organic solvent to the metal foil layer 4 and/or the sealant layer 3 and drying.

The polyolefin resin having the carboxyl group (hereinafter may sometimes be referred to as “carboxyl group-containing polyolefin resin”) is not particularly limited, but examples thereof include a modified polyolefin resin obtained by graft polymerizing ethylenically unsaturated carboxylic acid or acid anhydride thereof to a polyolefin, and a copolymerized resin of an olefin monomer and ethylenically unsaturated carboxylic acid, and the like. The polyolefin is not particularly limited, but examples thereof include homopolymers of olefin monomers such as ethylene, propylene, and butene, and copolymers of these olefin monomers. The ethylenically unsaturated carboxylic acid is not particularly limited, but examples thereof include acrylic acid, methacrylic acid, maleic acid, fumaric acid, crotonic acid, itaconic acid, and the like. These ethylenically unsaturated carboxylic acids may be used singly or in combination of two or more. As the carboxyl group-containing polyolefin resin, those soluble in an organic solvent are preferably used.

Among them, as the carboxyl group-containing polyolefin resin, it is preferable to use a modified polyolefin resin obtained by graft polymerizing an ethylenically unsaturated carboxylic acid or an acid anhydride thereof to a homopolymer of propylene or a copolymer of propylene and ethylene. The carboxyl group-containing polyolefin resin may have a single composition or may be a mixture of two or more compositions different in melting point.

The polyfunctional isocyanate compound acts as a curing agent for curing the adhesive composition by reacting with the carboxyl group-containing polyolefin resin. The polyfunctional isocyanate compound is not particularly limited, but examples thereof include tolylene diisocyanate, diphenylmethane diisocyanate, hexamethylene diisocyanate, isophorone diisocyanate, isocyanurate modified products of these diisocyanate compounds, burette modified products, or diisocyanate compounds modified by adduct modification with polyhydric alcohol such as trimethylolpropane, and the like. The polyfunctional isocyanate compound may be used singly or in combination of two or more kinds. As the polyfunctional isocyanate compound, a polyfunctional isocyanate compound soluble in an organic solvent is preferably used.

The organic solvent is not particularly limited as long as it can dissolve or disperse the carboxyl group-containing polyolefin resin. Of these, organic solvents capable of dissolving the carboxyl group-containing polyolefin resin are preferably used. Further, as the organic solvent, an organic solvent which is easy to remove the organic solvent from the adhesive liquid by volatilizing it by heating or the like is preferably used. The organic solvent that can dissolve the carboxyl group-containing polyolefin resin and is easily removed by volatilization by heating or the like is not particularly limited, but examples thereof include an aromatic based organic solvent such as toluene and xylene, an aliphatic based organic solvent such as n-hexane, a cycloaliphatic based organic solvent such as cyclohexane and methylcyclohexane (MCH), and a ketone based organic solvent such as methyl ethyl ketone (MEK). These organic solvents may be used alone, or two or more of them may be used in combination.

In the adhesive liquid or the adhesive resin composition, the equivalent ratio [NCO]/[OH] of the isocyanate group of the polyfunctional isocyanate compound to the hydroxyl group constituting the carboxyl group of the carboxyl group-containing polyolefin resin is preferably set to 0.5 to 10.0. If it is set in such a range, it is possible to obtain an adhesive composition having an excellent initial adhesive performance, and it is also possible to sufficiently suppress the deterioration over time of the adhesion strength between the metal foil layer 4 and the sealant layer 3 by an electrolyte of batteries for a longer period of time, which in turn can further improve the electrolyte resistance performance. The equivalent ratio [NCO]/[OH] is more preferably set to 1.0 to 9.0, particularly preferably 1.0 to 6.0.

If necessary, additives such as a reaction accelerator, a tackifier, a plasticizer, and the like may be contained in the adhesive liquid or the adhesive composition.

The thickness of the inner adhesive layer 6 is preferably set to 1 μm to 10 μm. When it is 1 μm or more, sufficient adhesive force can be obtained, and when it is 10 μm or less, the water vapor barrier property can also be improved.

In the aforementioned embodiment, the configuration in which the easily adhesive layer 8, the colored layer 9, the first adhesive layer 5, and the second adherent layer 6 are provided is adopted, but these layers are not indispensable constituent layers and it may be configured to adopt a configuration in which those layers are not provided.

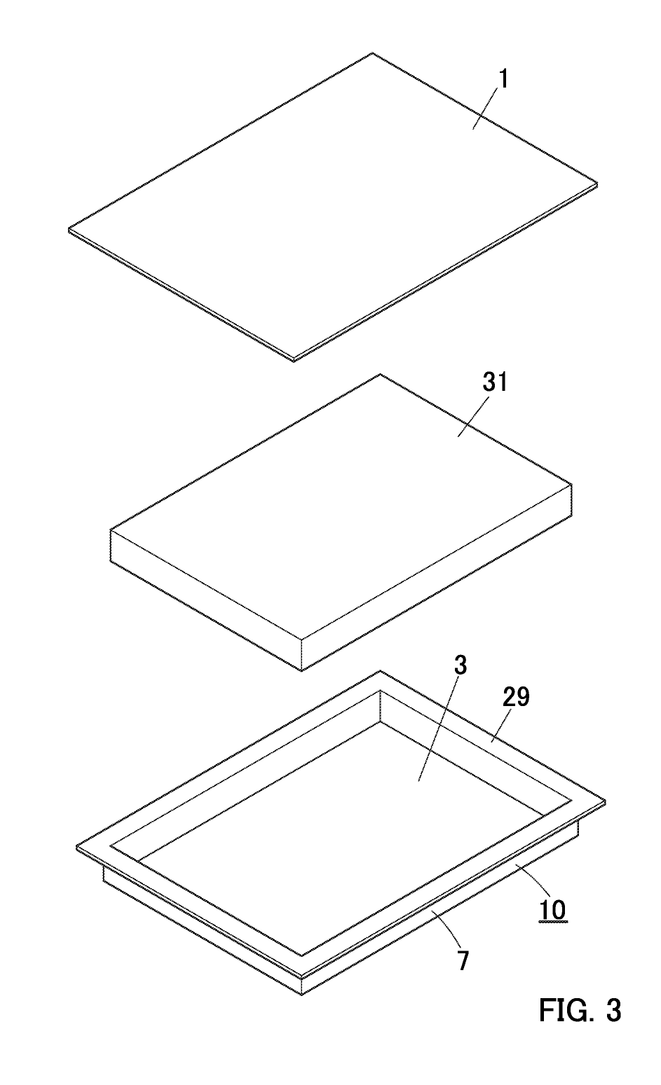

By shaping (deep drawing, stretch forming, etc.) the packaging material 1 for power storage devices of the present invention, a packaging case 10 for power storage devices can be obtained (see FIG. 3). The packaging material 1 of the present invention can be used as it is without being subjected to shaping (see FIG. 3).

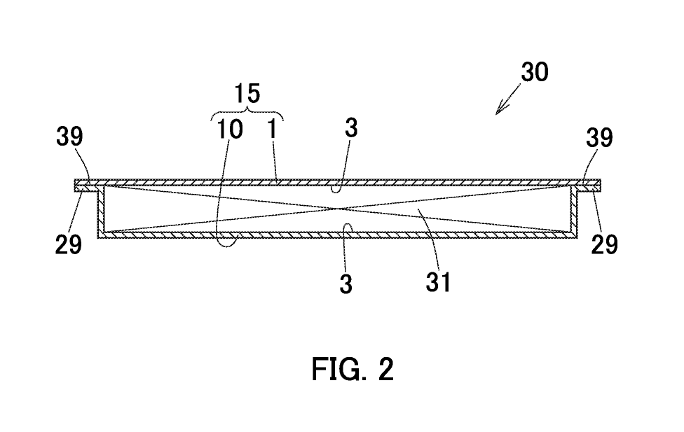

FIG. 2 shows an embodiment of a power storage device 30 configured using the packaging material 1 of the present invention. This power storage device 30 is a lithium ion secondary battery. In this embodiment, as shown in FIGS. 2 and 3, a packaging member 15 is constituted by a packaging case 10 obtained by shaping the packaging material 1 and a planar packaging material 1 not subjected to shaping. The power storage device 30 of the present invention is constituted (see FIGS. 2 and 3) by accommodating a substantially rectangular parallelepiped power storage device main body (electrochemical element or the like) 31 in an accommodation recess of an packaging case 10 obtained by shaping the packaging material 1 of the present invention, arranging a packaging material 1 of the present invention on the power storage device main body 31 without being shaped with its inner layer 3 side facing inward (lower side), and heat-sealing the peripheral portion of the inner layer 3 of the planar packaging material 1 and the inner layer 3 of the flange portion (sealing peripheral portion) 29 of the packaging case 10. The inner side surface of the accommodation recess of the packaging case 10 is an inner layer (sealant layer) 3, and the outer surface of the accommodation recess is a protective layer 7 (see FIG. 3).

In FIG. 2, the reference numeral 39 denotes a heat seal portion in which the peripheral portion of the packaging material 1 and the flange portion (sealing peripheral portion) 29 of the packaging case 10 are joined (fused). In the power storage device 30, the tip end portion of a tab lead connected to the power storage device main body 31 is led to the outside of the packaging member 15, but the illustration is omitted.

Although not particularly limited, the power storage device main body 31 may be exemplified by, for example, a battery main body portion, a capacitor main body portion, and an electrical condenser main body portion.

It is preferable that the width of the heat seal portion 39 be set to 0.5 mm or more. When it is set to 0.5 mm or more, sealing can be reliably performed. In particular, it is preferable that the width of the heat seal portion 39 be set to 3 mm to 15 mm.

In the aforementioned embodiment, the packaging member 15 is composed of the packaging case 10 obtained by shaping the packaging material 1 and the planar packaging material 1 (see FIGS. 2 and 3). However, the present invention is not particularly limited to such a combination. For example, the packaging member 15 may be constituted by a pair of packaging materials 1, or may be constituted by a pair of packaging cases 10.

### EXAMPLES

Next, specific examples of the present invention will be described. However, it should be noted that the present invention is not particularly limited to those of these examples.

### Example 1

50 parts by mass of carbon black having an average particle diameter of 0.8 μm, 5 parts by mass of ethylenediamine, and 45 part by mass of polyester based polyol (number average molecular weight: 2,500) were blended to obtain a main agent. 3 parts by mass of tolylene diisocyanate (TDI) which is a curing agent was blended to 100 parts by mass of the main agent, and 50 parts by mass of toluene was further blended and well stirred to obtain an ink composition.

Further, 70 parts by mass of “Takelac W-6010” manufactured by Mitsui Chemicals, Inc., as an aqueous urethane resin, 30 parts by mass of “Denacol EX-521” manufactured by Nagase Chemtech Corporation as an aqueous epoxy resin, 5 parts by mass of colloidal silica “Snowtex ST-C” (average particle diameter of 10 nm to 20 nm) manufactured by Nissan Chemical Industries, Ltd., as an anti-blocking agent were mixed, and ion exchanged water was added to dilute. Thus, an adhesive composition for forming an easily adhesive layer having 2 mass % of a nonvolatile content rate was obtained.

Next, after applying the adhesive composition for forming an easily adhesive layer by a gravure roll coating method on one surface a biaxially stretched nylon (6 nylon) film 2 (heat resistant resin stretched film layer, MD/TD=0.95) having a thickness of 15 μm and a hot water shrinkage percentage of 4.0% obtained by stretching with a simultaneous biaxial stretching method by a gravure roll coating method and drying, the curing reaction was allowed to progress by leaving for one day under the environment of 40° C. Thus, an easily adhesive layer 8 having a formed amount of 0.1 g/m² was formed.

Next, the ink composition was printed (applied) on the surface of the easily adhesive layer 8 of the biaxially stretched nylon film 2 by a gravure printing method and then left for one day under the environment of 40° C., so that the crosslinking reaction and drying were proceeded to thereby form a colored layer (black ink layer) 9 having a thickness of 3 μm. Thus, the first laminate was obtained.

Further, after applying a protective layer forming composition composed of: 55 parts by mass of polyester (number average molecular weight: 5,300) having a hydroxyl group at respective both ends of the main chain in the longitudinal direction; 13 parts by mass of an adduct (denoted as “adduct A” in the table) of trimethylolpropane and hexamethylene diisocyanate; 2 part by mass of powdery silica having an average particle diameter of 2 μm; 20 parts by mass of barium sulfate having an average particle diameter of 2 μm; 5 parts by mass of acrylic resin beads having an average particle diameter of 7 μm; 5 parts by mass of polyethylene wax; and 100 parts by mass of a solvent (50 parts by mass of methyl ethyl ketone: 50 parts by mass of toluene) on the biaxially stretched nylon film 2 of the first lamination (on the non-laminated surface), the reaction was allowed to proceed by leaving it under the environment at 60° C. for 3 days to form a protective layer 7 having a thickness of 2 μm to obtain a second laminate. In the composition for forming the protective layer, the equivalent ratio [NCO]/[0H+COOH] was 2.9.

On the other hand, a chemical conversion treatment solution composed of polyacrylic acid, phosphoric acid, a trivalent chromium compound, water, and alcohol was applied to both sides of an aluminum foil 4 having a thickness of 35 μm and dried at 180° C. so that a chromium adhesion amount became 5 mg/m².

Next, the second laminate was bonded to one surface of the aluminum conversion-treated aluminum foil 4 on the colored layer (black ink layer) 9 side via a polyester polyurethane adhesive 5. Next, an unstretched polypropylene film (thermoplastic resin layer) 3 having a thickness of 30 μm was bonded to the other surface of the aluminum foil 4 via a maleic anhydride-modified polypropylene adhesive 6. The packaging material 1 for power storage devices shown in FIG. 1 was obtained by leaving for 5 days under the 40° C. environment.

### Example 2

In the composition for forming the protective layer, a packaging material 1 for power storage devices shown in FIG. 1 was obtained in the same manner as in Example 1 except that “55 parts by mass of polyester (number average molecular weight: 5,300) having a hydroxyl group at respective both ends of the main chain in the longitudinal direction, and 13 parts by mass of an adduct of trimethylolpropane and hexamethylene diisocyanate” was changed to “63 parts by mass of polyester (number average molecular weight: 9,800) having a hydroxyl group at respective both ends of the main chain in the longitudinal direction, and 5 parts by mass of an adduct of trimethylolpropane and hexamethylene diisocyanate” and a composition for forming a protective layer having an equivalent ratio [NCO]/[OH+COOH] of 1.8 was used.

### Example 3

A packaging material 1 for power storage devices shown in FIG. 1 was obtained in the same manner as in Example 2 except that a composition in which erucic acid amide having a concentration of 5,000 ppm was added to the composition for forming a protection layer in Example 2 was used as a composition for forming a protective layer.

### Example 4

A packaging material 1 for power storage devices shown in FIG. 1 was obtained in the same manner as in Example 1 except that in the composition for forming a protective layer, “55 part by mass of a polyester (number average molecular weight: 5,300) having a hydroxyl group at respective both ends of the main chain in the longitudinal direction, and 13 parts by mass of an adduct of trimethylolpropane and hexamethylene diisocyanate” was changed to “65 part by mass of polyester (number average molecular weight: 14,500) having a hydroxyl group at respective both ends of the main chain in the longitudinal direction, and “3 parts by mass of an adduct with trimethylolpropane and hexamethylene diisocyanate” and a composition for forming a protective layer having an equivalent ratio [NCO]/[OH+COOH] of 1.6 was used.

### Example 5

A packaging material 1 for power storage devices shown in FIG. 1 was obtained in the same manner as in Example 4 except that in the composition for forming a protective layer, “3 parts by mass of an adduct of trimethylolpropane and hexamethylene diisocyanate” was changed to “1.5 parts by mass of an adduct of trimethylolpropane and hexamethylene diisocyanate and 1.5 parts by mass of an adduct of trimethylolpropane and tolylene diisocyanate (TDI)”.

### Example 6

A packaging material 1 for power storage devices shown in FIG. 1 was obtained in the same manner as in Example 1 except that in the composition for forming a protective layer, “55 parts by mass of polyester (number average molecular weight: 5,300) having a hydroxyl group at respective both ends of the main chain in the longitudinal direction, and 13 parts by mass of an adduct of trimethylolpropane and hexamethylene diisocyanate” was changed to “65 parts by mass of polyester (number average molecular weight: 14,500) having a hydroxyl group at respective both ends of the main chain in the longitudinal direction, and 3 parts by mass of an adduct of pentaerythritol and hexamethylene diisocyanate” and a composition for forming a protective layer having an equivalent ratio [NCO]/[OH+COOH] of 1.7 was used.

### Example 7

A packaging material 1 for power storage devices shown in FIG. 1 was obtained in the same manner as in Example 4 except that in place of the polyester (number average molecular weight: 14,500) having a hydroxyl group at respective both ends of the main chain in the longitudinal direction, and a polyester (number average molecular weight: 19,600) was used.

### Example 8

A packaging material 1 for power storage devices shown in FIG. 1 was obtained in the same manner as in Example 4 except that in place of the polyester (number average molecular weight: 14,500) having a hydroxyl group at respective both ends of the main chain in the longitudinal direction, and a polyester (number average molecular weight: 28,500) was used.

### Example 9

A packaging material 1 for power storage devices shown in FIG. 1 was obtained in the same manner as in Example 1 except that in place of the polyester (number average molecular weight: 5,300) having a hydroxyl group at respective both ends of the main chain in the longitudinal direction, and a polyester (number average molecular weight: 49,000) was used.

### Example 10

A packaging material 1 for power storage devices shown in FIG. 1 was obtained in the same manner as in Example 3 except that in place of the polyester (number average molecular weight: 9,800) having a hydroxyl group at respective both ends of the main chain in the longitudinal direction, a polyester (number average molecular weight: 9,800) having a carboxyl group at respective both ends of the main chain in the longitudinal direction was used.

### Example 11

A packaging material 1 for power storage devices shown in FIG. 1 was obtained in the same manner as in Example 2 except that as a composition for forming a protective layer, a composition composed of 57 part by mass of polyester (number average molecular weight: 9,800) having a hydroxyl group at respective both ends of the main chain in the longitudinal direction, 10 parts by mass of an adduct of trimethylolpropane and hexamethylene diisocyanate, 1 part by mass of trimethylolpropane (polyhydric alcohol), 2 part by mass of powdery silica having an average particle diameter of 2 μm, 20 parts by mass of barium sulfate having an average particle diameter of 2 μm, 5 parts by mass of acrylic resin beads having an average particle diameter of 7 μm, and 5 parts by mass of wax was used.

### Example 12

A packaging material 1 for power storage devices shown in FIG. 1 was obtained in the same manner as in Example 2 except that as a composition for forming a protective layer, a composition composed of 57 parts by mass of polyester (number average molecular weight: 9,800) having a hydroxyl group at respective both ends of the main chain in the longitudinal direction, 10 parts by mass of an adduct of trimethylolpropane and hexamethylene diisocyanate, 1 part by mass of pentaerythritol (polyhydric alcohol), 2 part by mass of powdery silica having an average particle diameter of 2 μm, 20 parts by mass of barium sulfate having an average particle diameter of 2 μm, 5 parts by mass of acrylic resin beads having an average particle diameter of 7 μm, and 5 parts by mass of wax was used.

### Example 13

A packaging material 1 for power storage devices shown in FIG. 1 was obtained in the same manner as in Example 2 except that as a composition for forming a protective layer, a composition composed of 57 parts by mass of polyester (number average molecular weight: 9,800) having a hydroxyl group at respective both ends of the main chain in the longitudinal direction, 10 parts by mass of an adduct of trimethylolpropane and hexamethylene diisocyanate, 1 part by mass of glycerin (polyhydric alcohol), 2 parts by mass of powdery silica having an average particle diameter of 2 μm, 20 parts by mass of barium sulfate having an average particle diameter of 2 μm, 5 parts by mass of acrylic based resin beads having an average particle diameter of 7 μm, and 5 parts by mass of wax was used.

### Example 14

A packaging material 1 for power storage devices shown in FIG. 1 was obtained in the same manner as in Example 1 except that in the composition for forming a protective layer, “55 parts by mass of polyester (number average molecular weight: 5,300) having a hydroxyl group at respective both ends of the main chain in the longitudinal direction, and 13 parts by mass of an adduct of trimethylolpropane and hexamethylene diisocyanate” was changed to “65 parts by mass of polyester (number average molecular weight: 14,200) equipped with four hydroxyl groups including a hydroxyl group at respective both ends in the length direction of the main chain (having a hydroxyl group at respective both ends in the length direction of the main chain and two hydroxyl groups at the middle of chain of the main chain hydroxyl group), and 3 parts by mass of an adduct of trimethylolpropane and hexamethylene diisocyanate” and a composition for forming a protective layer having an equivalent ratio [NCO]/[OH+COOH] of 0.8 was used.

### Example 15

A packaging material 1 for power storage devices shown in FIG. 1 was obtained in the same manner as in Example 1 except that in the composition for forming a protective layer, “55 parts by mass of polyester (number average molecular weight: 5,300) having a hydroxyl group at respective both ends of the main chain in the longitudinal direction, and 13 parts by mass of an adduct of trimethylolpropane and hexamethylene diisocyanate” was changed to “65 parts by mass of polyester (number average molecular weight: 11,200) equipped with four hydroxyl groups including a hydroxyl group at respective both ends in the length direction of the main chain (having a hydroxyl group at respective both ends in the length direction of the main chain and two hydroxyl groups at the middle of chain of the main chain hydroxyl group), and 3 parts by mass of an adduct of trimethylolpropane and hexamethylene diisocyanate” and a composition for forming a protective layer having an equivalent ratio [NCO]/[OH+COOH] of 0.9 was used.

### Comparative Example 1

A packaging material 1 for power storage devices shown in FIG. 1 was obtained in the same manner as in Example 1 except that as a composition for forming a protective layer, a composition for forming a protective layer composed of 65 parts by mass of fluorine-containing polyol (number average molecular weight: 15,000), 3 parts by mass of an adduct of trimethylolpropane and hexamethylene diisocyanate, 2 part by mass of powdery silica having an average particle diameter of 2 μm, 20 parts by mass of barium sulfate having an average particle diameter of 2 μm, 5 parts by mass of an acrylic resin beads wax having an average particle diameter of 7 μm, and 5 parts by mass of wax was used.

### Comparative Example 2

A packaging material 1 for power storage devices shown in FIG. 1 was obtained in the same manner as in Example 1 except that as a composition for forming a protective layer, a composition for forming a protective layer composed of 53 parts by mass of polyurethane polyol (number average molecular weight: 5,400), 15 parts by mass of an adduct of trimethylolpropane and hexamethylene diisocyanate, 2 part by mass of powdery silica having an average particle diameter of 2 μm, 20 parts by mass of a barium sulfate having an average particle diameter of 2 μm, 5 parts by mass of an acrylic based resin beads wax having an average particle diameter of 7 μm, and 5 parts of mass of wax was used.

### Comparative Example 3

A packaging material 1 for power storage devices shown in FIG. 1 was obtained in the same manner as in Example 1 except that as a composition for forming a protective layer, a composition for forming a protective layer composed of 53 parts by mass of acryl based polyol (number average molecular weight: 3,400), 15 parts by mass of an adduct of trimethylolpropane and hexamethylene diisocyanate, 2 parts by mass of powdery silica having an average particle diameter of 2 μm, 20 parts by mass of a barium sulfate having an average particle diameter of 2 μm, 5 parts by mass of an acrylic resin beads wax having an average particle diameter 7 μm, and 5 parts by mass of wax was used.

### Comparative Example 4

A packaging material 1 for power storage devices shown in FIG. 1 was obtained in the same manner as in Example 1 except that in the composition for forming a protective layer, “55 parts by mass of polyester (number average molecular weight: 5,300) having a hydroxyl group at respective both ends of the main chain in the longitudinal direction, and 13 parts by mass of an adduct of trimethylolpropane and hexamethylene diisocyanate” was changed to 53 parts by mass of polyester (number average molecular weight: 3,900) having a hydroxyl group at respective both ends of the main chain in the longitudinal direction, and 15 parts by mass of an adduct of pentaerythritol and hexamethylene diisocyanate” and a composition for forming a protective layer having an equivalent ratio [NCO]/[OH+COOH] of 2.6 was used.

### Comparative Example 5

A packaging material 1 for power storage devices shown in FIG. 1 was obtained in the same manner as in Example 1 except that in the composition for forming a protective layer, “13 parts by mass of an adduct of trimethylolpropane and hexamethylene diisocyanate” was changed to “13 parts by mass of an adduct of trimethylolpropane and tolylene diisocyanate (TDI)”.

In tables, the adduct of trimethylolpropane and hexamethylene diisocyanate (HMDI) is denoted as “Adduct A”, the adduct of pentaerythritol and hexamethylene diisocyanate (HMDI) is denoted as “Adduct B”, and the adduct of trimethylolpropane and tolylene diisocyanate (TDI) is denoted as “Adduct C”.

TABLE 1

| | | | | | Comp. | | | | | | | | Com. |
|---|---|---|---|---|---|---|---|---|---|---|---|---|---|
| | | | | | Ex. 4 | Ex. 1 | Ex. 2 | Ex. 3 | Ex. 4 | Ex. 5 | Ex. 6 | Ex. 7 | Ex. 5 |
| Composition | Resin | Compo- | Polyester | Both ends | OH | OH | OH | OH | OH | OH | OH | OH | OH |
| of protective | | nents | polyol | Number | 3900 | 5300 | 9800 | 9800 | 14500 | 14500 | 14500 | 19600 | 5300 |
| layer | | | | average | | | | | | | | | |
| | | | | molecular | | | | | | | | | |
| | | | | weight | | | | | | | | | |

| | | | | | | | | | |
|---|---|---|---|---|---|---|---|---|---|
| Multifunctional | Adduct | Adduct | Adduct | Adduct | Adduct | A/C | Adduct | Adduct | Adduct |
| isocyanate | A | A | A | A | A | | B | A | C |
| curing agent | | | | | | | | | |
| Polyhydric alcohol | — | — | — | — | — | — | — | — | — |

| | | | | | | | | | | |
|---|---|---|---|---|---|---|---|---|---|---|
| | [NCO]/[OH + COOH] | 2.6 | 2.9 | 1.8 | 1.8 | 1.6 | 1.6 | 1.7 | 1.8 | 2.9 |
| | Type of resin | ESTER | ESTER | ESTER | ESTER | ESTER | ESTER | ESTER | ESTER | ESTER |
| | Content rate of resin (mass %) | 68 | 68 | 68 | 67.5 | 68 | 68 | 68 | 68 | 68 |
| Solid | Silica (mass %) | 2 | 2 | 2 | 2 | 2 | 2 | 2 | 2 | 2 |
| fine | Barium sulfate (mass %) | 20 | 20 | 20 | 20 | 20 | 20 | 20 | 20 | 20 |
| particle | Resin beads (mass %) | 5 | 5 | 5 | 5 | 5 | 5 | 5 | 5 | 5 |
| Lubricant | Wax (mass %) | 5 | 5 | 5 | 5 | 5 | 5 | 5 | 5 | 5 |
| | Erucic acid amide (ppm) | — | — | — | 5000 | — | — | — | — | — |

| | | | | | | | | | | |
|---|---|---|---|---|---|---|---|---|---|---|
| Evaluation | Formability | ◯ | ◯ | ◯ | ⊚ | ◯ | ◯ | ◯ | ◯ | ◯ |
| | Printability | ⊚ | ⊚ | ⊚ | ⊚ | ⊚ | ⊚ | ⊚ | ⊚ | ⊚ |
| | Solvent resistance (ethanol) | ◯ | ◯ | ⊚ | ⊚ | ⊚ | ◯ | ◯ | ⊚ | ◯ |
| | Solvent resistance (MEK) | X | Δ | ⊚ | ⊚ | ⊚ | Δ | © | ⊚ | X |

ESTER: Polyester resin
A/C: Adduct body A (aliphatic type)/Adduct body C (aromatic type)

TABLE 2

| | | | | | Ex. 8 | Ex. 9 | Ex. 10 | Ex. 11 | Ex. 12 | Ex. 13 | Ex. 14 | Ex. 15 |
|---|---|---|---|---|---|---|---|---|---|---|---|---|
| Composition | Resin | Compo- | Polyester | Both ends | OH | OH | COOH | OH | OH | OH | *1) | *1) |
| of protective | | nents | polyol | Number | 28500 | 49000 | 9800 | 9800 | 9800 | 9800 | 14200 | 11200 |
| layer | | | | average | | | | | | | | |
| | | | | molecular | | | | | | | | |
| | | | | weight | | | | | | | | |

| | | | | | | | | |
|---|---|---|---|---|---|---|---|---|
| Multifunctional | Adduct | Adduct | Adduct | Adduct | Adduct | Adduct | Adduct | Adduct |
| isocyanate | A | A | A | A | A | A | A | A |
| curing agent | | | | | | | | |
| Polyhydric alcohol | — | — | — | Trimethylol | Pentaeryth- | Glycerin | — | — |
| | | | | propane | ritol | | | |

| | | | | | | | | | |
|---|---|---|---|---|---|---|---|---|---|
| | [NCO]/[OH + COOH] | 2.6 | 3.5 | 1.8 | 0.8 | 0.6 | 0.6 | 0.8 | 1.1 |
| | Type of resin | ESTER | ESTER | ESTER | ESTER | ESTER | ESTER | ESTER | ESTER |
| | Content rate of resin (mass %) | 68 | 68 | 67.5 | 68 | 68 | 68 | 68 | 68 |
| Solid | Silica (mass %) | 2 | 2 | 2 | 2 | 2 | 2 | 2 | 2 |
| fine | Barium sulfate (mass %) | 20 | 20 | 20 | 20 | 20 | 20 | 20 | 20 |
| particle | Resin beads (mass %) | 5 | 5 | 5 | 5 | 5 | 5 | 5 | 5 |
| Lubricant | Wax (mass %) | 5 | 5 | 5 | 5 | 5 | 5 | 5 | 5 |
| | Erucic acid amide (ppm) | — | — | 5000 | — | — | — | — | — |

| | | | | | | | | | |
|---|---|---|---|---|---|---|---|---|---|
| Evaluation | Formability | ◯ | ◯ | ⊚ | ◯ | ◯ | ◯ | ◯ | ◯ |
| | Printability | ⊚ | ⊚ | ⊚ | ⊚ | ⊚ | ⊚ | ⊚ | ⊚ |
| | Solvent resistance (ethanol) | ⊚ | ⊚ | ⊚ | ⊚ | ⊚ | ⊚ | ⊚ | ⊚ |
| | Solvent resistance (MEK) | ⊚ | ⊚ | ⊚ | ⊚ | ⊚ | ⊚ | ⊚ | ⊚ |

ESTER: Polyester resin
*1): having OH group at respective both ends of the main chain and two OH groups in the middle of the main chain

TABLE 3

| | | | | | Comp. Ex. 1 | Comp. Ex. 2 | Comp. Ex. 3 |
|---|---|---|---|---|---|---|---|
| Composition | Resin | Compo- | Polyester | Both ends | Fluorine based | Urethane based | Acryl based |
| of protective | | nents | polyol | Number | 15000 | 5400 | 3400 |
| layer | | | | average | | | |
| | | | | molecular | | | |
| | | | | weight | | | |

| | | | |
|---|---|---|---|
| Multifunctional | Adduct | Adduct | Adduct |
| isocyanate | A | A | A |
| curing agent | | | |
| Polyhydric alcohol | — | — | — |

| | | | | |
|---|---|---|---|---|
| | [NCO]/[OH + COOH] | 1.1 | 3.1 | 1.5 |
| | Type of resin | Fluorine-based | Polyurethane | Polyacrylic |
| | | polyurethane | | polyurethane |
| | Content rate of resin (mass %) | 68 | 68 | 68 |
| Solid | Silica (mass %) | 2 | 2 | 2 |
| fine | Barium sulfate (mass %) | 20 | 20 | 20 |
| particle | Resin beads (mass %) | 5 | 5 | 5 |
| Lubricant | Wax (mass %) | 5 | 5 | 5 |
| | Erucic acid amide (ppm) | — | — | — |

| | | | | |
|---|---|---|---|---|
| Evaluation | Formability | ◯ | ◯ | ◯ |
| | Printability | X | ⊚ | ⊚ |
| | Solvent resistance (ethanol) | ⊚ | Δ | Δ |
| | Solvent resistance (MEK) | ⊚ | X | X |

Each packaging material for power storage devices obtained as described above was evaluated based on the following evaluation method. The results are shown in Tables 1 to 3.

### <Formability Evaluation Method>

Using a stretch forming machine (product number: TP-25C-X2) manufactured by Amada Co., Ltd., a packaging material for power storage devices was stretch-formed into a rectangular parallelepiped shape of 55 mm in length×35 mm in width×8 mm in depth, and formability was evaluated based on the following criteria.

### (Judgment Criteria)

“⊚”: There was no pinhole at all and no cracks occurred.

“◯”: There were no pinholes and cracks, but slight white turbidity was observed in the protective layer

“Δ”: Very few pinholes were generated, but there was substantially no pinhole

“X”: Pinholes and cracks occurred at the corners

### <Printability Evaluation Method>

A barcode (dot size: 0.25 mm in diameter) was printed with white ink on the surface (outer surface) of the protective layer of each packaging material using an ink jet printer. Next, the printability was evaluated based on the following judgment criteria from the viewpoints of whether or not the printed barcode can be read without any problem with the barcode reader, and whether or not the printed barcode has bleeding.

### (Judgment Criteria)

“⊚”: It could be read without problems with a barcode reader. There was no ink bleeding.

“◯”: It could be read without problems with a barcode reader. There was a slight ink bleeding, but no problem.

“Δ”: Ink bleeding was recognized to a certain extent, but it could be read without problems with a barcode reader.

“X”: I could not read it with a barcode reader. The extent of ink bleeding was large.

### <Solvent Resistance Evaluation Method (Ethanol)>

Each packaging material was cut into a size of 10 cm in length×10 cm in width to obtain a test piece. 1 mL (1 cc) of ethanol was dropped on the surface (outer surface) of the protective layer of the test piece. Thereafter, the droplet adhered portion of the test piece was rubbed 10 times back and forth with a sliding member in which cotton was wrapped around a weight of 1 cm in diameter and 1 kg in weight. The appearance of the surface (outer surface) of the protective layer of the test piece after 10 reciprocations was visually checked, and based on the following criteria, solvent resistance (ethanol) was evaluated.

### (Judgment Criteria)

“⊚”: There was no change in appearance even after 10 reciprocations.

“◯”: There was no change in appearance from the first to seventh reciprocations, but the appearance changed after eighth reciprocation.

“Δ”: There was no change in appearance from the first to fourth reciprocations, but the appearance changed after the fifth reciprocation.

“X”: Appearance changed in one reciprocation (solvent resistance defect).

### <Solvent Resistance Evaluation Method (Methyl Ethyl Ketone)>

The solvent resistance (methyl ethyl ketone) was evaluated in the same manner as the aforementioned solvent resistance evaluation method (ethanol), except that 1 mL of methyl ethyl ketone (MEK) was used instead of 1 mL of ethanol. The judgment criteria are the same as the above criteria for determination in the solvent resistance evaluation method (ethanol).

As is apparent from the tables, the packaging materials for power storage devices of Examples 1 to 15 of the present invention were excellent in formability, excellent in printability, and excellent in solvent resistance.

On the other hand, in Comparative Examples 1 to 5 which deviate from the specified range of the present invention, there were the following problems. That is, in the packaging material of Comparative Example 1, the printability was bad. In the packaging materials of Comparative Examples 2 to 5, the solvent resistance to MEK was extremely poor.

### INDUSTRIAL APPLICABILITY

The packaging material for power storage devices according to the present invention and the packaging case for power storage devices according to the present invention can be used as various types of packaging materials or packaging cases for power storage devices specifically exemplified by: e.g.,
a power storage device such as a lithium secondary battery (lithium ion battery, lithium polymer battery, etc.)
a lithium-ion capacitor
an electric double layer capacitor
an all solid state battery.

As the power storage device according to the present invention, the aforementioned various power storage devices can be exemplified.

The present application claims priority to Japanese Patent Application No. 2016-254888 filed on Dec. 28, 2016, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention. The present invention allows any design changes unless departing from its spirit within the scope of the claims.

### DESCRIPTION OF REFERENCE SYMBOLS

1: packaging material for power storage device
2: base material layer
3: sealant layer (inner layer)
4: metal foil layer
5: first adhesive layer (outer adhesive layer)
6: second adhesive layer (inner adhesive layer)
7: protective layer
8: easily adhesive layer
9: colored layer
10: packaging case for power storage device (shaped body)
15: packaging member
30: power storage device
31: power storage device main body

1. A packaging material for power storage devices, comprising:
a base material layer made of a heat resistant resin;
a sealant layer as an inner layer; and
a metal foil layer arranged between the base material layer and the sealant layer,
wherein a protective layer is laminated on a surface of the base material layer opposite to a metal foil layer side, and
wherein the protective layer contains 40 mass % or more of a polyester resin formed by polyester polyol having a number average molecular weight of 5,000 to 50,000 and having a hydroxyl group or a carboxyl group independently at least at respective both ends thereof and a multifunctional isocyanate curing agent containing at least an aliphatic polyfunctional isocyanate compound.

2. The packaging material for power storage devices as recited in claim 1,
wherein an equivalent ratio [NCO]/[OH+COOH] is 0.5 to 5, the equivalent ratio being a ratio of the number of moles of an isocyanate group of the multifunctional isocyanate curing agent to a sum of the number of moles of the hydroxyl group and the number of moles of the carboxyl group.

3. The packaging material for power storage devices as recited in claim 1,
wherein the aliphatic polyfunctional isocyanate compound is at least one aliphatic polyfunctional isocyanate compound selected from the group consisting of an adduct of trimethylolpropane and an aliphatic diisocyanate compound and an adduct of pentaerythritol and an aliphatic diisocyanate compound.

4. The packaging material for power storage devices as recited in claim 1,
wherein the polyester resin composing the protective layer is a polyester resin formed by the polyester polyol, the multifunctional isocyanate curing agent, and a trihydric or higher polyhydric alcohol.

5. The packaging material for power storage devices as recited in claim 1,
wherein the protective layer contains solid fine particles having an average particle diameter of 1 μm to 10 μm.

6. The packaging material for power storage devices as recited in claim 1,
wherein the protective layer contains a lubricant.

7. The packaging material for power storage devices as recited in claim 1,
wherein a colored layer is arranged between the base material layer and the metal foil layer.

8. The packaging material for power storage devices as recited in claim 7,
wherein the base material layer and the colored layer are integrally laminated via an easily adhesive layer.

9. A packaging case for power storage devices, the packaging case being composed of a shaped body of the packaging material for power storage devices as recited in claim 1.

10. A power storage device, comprising:
a power storage device main body; and
a packaging material composed of the packaging material for power storage devices as recited in claim 1 and a packaging case for power storage devices,
wherein the power storage device main body is packaged with the packaging material.
